(19) United States
(12) Patent Application Publication
(10) Pub. No.: US 2011/0070410 A1
(43) Pub. Date: Mar. 24, 2011

(54) Fire-resistant board

(76) Inventors: Chi-Lung Huang, Changhua County (TW); Hung-Chun Chiang, Changhua County (TW); Cheng-Chung Tsai, Changhua County (TW)

(21) Appl. No.: 12/586,584

(22) Filed: Sep. 24, 2009

(51) Int. Cl. C09K 21/02; B32B 21/04; B32B 5/00

(52) U.S. Cl. 428/195.1; 252/601; 442/1; 428/451; 428/452; 442/327

(57) ABSTRACT

An environmentally-friendly, fire-resistant board includes a primary layer mainly made of a composition comprised of a magnesite compound and carborundum, wherein the primary layer enables the fire-resistant board to resist fire, to retard flame, to endure water and moisture, to prevent deformation, and to withstand bend as well as impact.

### BACKGROUND OF THE INVENTION

1. Technical Field

The present invention relates to finishing boards for buildings and furniture, and more particularly, to a board mainly made of a composition comprised of a magnesite compound and carborundum, which board is capable of resisting fire, retarding flame, enduring water and moisture, preventing deforming, and withstanding bend as well as impact.

2. Description of Related Art

A conventional fire-resistant laminated board is typically composed of a decorative layer, a flameproof layer and a base layer laminated in sequence. The upmost decorative layer is intended to be waterproof and wearproof, and may be realized by a melamine board, a coated color board, a block board, an acrylic board, a plastic board, a resin board, a log board or a plywood board. The flameproof layer is typically made of stacked paper or fabric impregnated with a fire retardant solution so as to be flameproof. The base layer forms a foundation of the laminated board and may be realized by a block board, an acrylic board, a resin board, a plastic board, a log board or a plywood board. The existing laminated board is advantageous for its competent flame resistance out of the intermediate layer formed by the retardant-impregnated paper or fabric. However, in the case that the laminated board has its decorative layer and base layer made of acryl or the like, its production generates toxicant substance and pernicious pollutants and causes pollution and harms the environment and human. In addition, the intermediate layer formed by the stacked paper or fabric can significantly weaken the overall structural strength of the laminated board, causing the laminated board to be inferior in preventing deforming, enduring water and moisture, and withstanding bend as well as impact. Consequently, the conventional laminated board can only be used indoors as a finishing board for interior decoration and furniture, and is not a suitable material for partitions, walls and floors.

### SUMMARY OF THE INVENTION

The present invention provides a fire-resistant board including a primary layer mainly made of a composition comprised of a magnesite compound and carborundum, in addition to wood flour, fiberglass mesh cloth, and crystal water. Thereby, the primary layer has the following physical features:

Flameproof ability: the 5 mm primary layer possesses a heat-resisting limit of 600˜800° C., and a thermal conductivity less than 0.3 w/mk.

Moisture-proof and anti-deforming ability: the primary layer has a dry-shrinkage ratio≦0.3% and a wet-distortion rate≦0.6%.

Heat insulation: the primary layer has a heat resistance of 1.14 m²k/w.

Bendability and anti-impact strength: the primary layer has an anti-bending strength≧10 Mpa and an anti-impact strength≧2 Kj/m².

Sound insulation: a sound insulating wall constructed from the disclose primary layer of 95 mm provides a sound insulating effect equal to that of a 123 mm wall constructed from four layers of 12 mm gypsum boards, and also equal to that of a 150 mm standard solid-brick wall.

Besides, the primary layer of the present invention is light yet strong and has a unit weight as light as 700˜1500 kg/m³, about one tenth of the weight of a standard solid-brick wall while providing an anti-impact strength as high as 2 to 3 times of that of a gypsum wall at the same thickness.

The disclosed fire-resistant board can be cut, sawed and trimmed into proper sizes at will. The board is flexible and may be slightly bent to meet various surfaces. Also, the board is adaptive to be bound with surfaces of building walls, floors, upholstery and furniture.

According to the present invention, the environmentally friendly, fire-resistant board includes:

a primary layer made of a composition comprised of a magnesite compound and carborundum;

a surface layer bound with an upper surface of the primary layer by means of adhesion, thermal transfer or painting; and

an adhesive layer provided at a lower surface of the primary layer.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawing, wherein:

FIG. 1 is a partial perspective view of a primary layer of a fire-resistant board according to the present invention;

FIG. 2 is a cross sectional view of the primary layer of FIG. 1;

FIG. 3 is an exploded view of the fire-resistant board according to the present invention having a primary layer, a surface layer and an adhesive layer;

FIG. 4 is a perspective view of the fire-resistant board of FIG. 3;

FIG. 5 is a cross sectional view of the fire-resistant board of FIG. 3;

FIG. 6 is a schematic drawing showing the surface layer of the fire-resistant board of the present invention covered by a film of wooden veneer; and

FIG. 7 is a cross sectional view of the fire-resistant board added with a cushion layer bottommost.

### DETAILED DESCRIPTION OF THE PREFERRED EMBODIMENTS

While the preferred embodiments provided hereinafter for illustrating the concept of the present invention as described above, it is to be understood that the components of the embodiments shown in the accompanying drawings are depicted for the sake of easy explanation and need not to be made in scale.

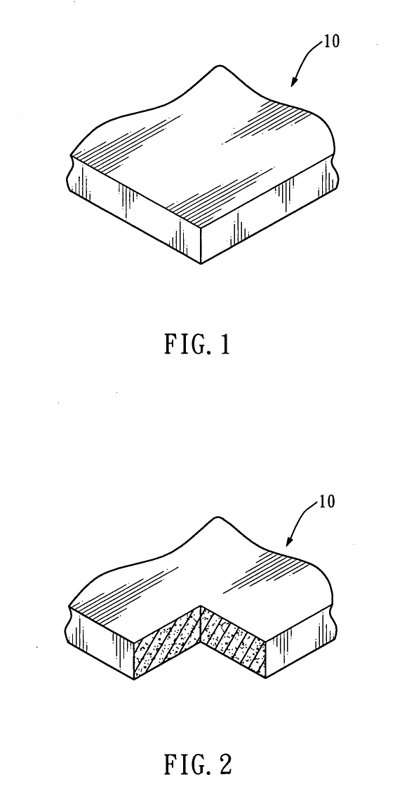

Referring to FIGS. 1 and 2, an environmentally friendly, fire-resistant board of the present invention comprises a primary layer mainly made of a composition comprised of a magnesite compound and carborundum. Other materials forming the primary layer may include wood flour, fiberglass mesh cloth and crystal water. A coloring agent may be added as needed. The magnesite compound comprises magnesium chloride, magnesium oxide, and magnesium sulfate. The primary layer 10 includes the magnesite compound ranging between 37 wt % and 47 wt %, carborundum (also known as silicon-carbide) ranging between 11 wt % and 21 wt %, wood flour ranging between 31 wt % and 41 wt %, crystal water ranging between 5 wt % and 8 wt %. The use amount of the fiberglass mesh cloth is 127 g/m, while the coloring agent is used as needed. To make the primary layer 10, the magnesite compound, carborundum, wood flour and crystal water are well mixed and applied to the fiberglass mesh cloth. After 7 to 30 days of storage at the room temperature, the mixture is cured to form a solid board, namely the primary layer 10. The solid primary layer 10 has a unit weight of 700˜1500 kg/m³, a bendability≧10 Mpa, an anti-impact strength≧2 Kj/m², a dry-shrinkage ratio≦0.3%, a wet-distortion rate≦0.6% and a concentration of chlorine ion≦10%. The primary layer 10 of a thickness of 5 mm has a heat-resisting limit of 600˜800° C., and a thermal conductivity less than 0.3 w/mk, meeting Class A Flame Retardancy of the Chinese National Standards. Owing to the above properties, it is confirmed that the primary layer 10 performs excellent flame retardancy, moisture withstanding ability, heat insulation, bendability, anti-impact strength, and sound insulation, and has good flexibility, tenacity as well as structural strength. Moreover, the primary layer 10 is asbestos-free and formaldehyde-free, thus being environmentally friendly. It has been also proven by experiments that the used primary layer 10 can be naturally decomposed in soil without damaging the earth.

The solid primary layer 10 may have its surface polished through a grinding process. The primary layer 10 may be affixed to an external physical surface, a frame or a concrete wall by means of self tapping screws, nails or other fasteners.

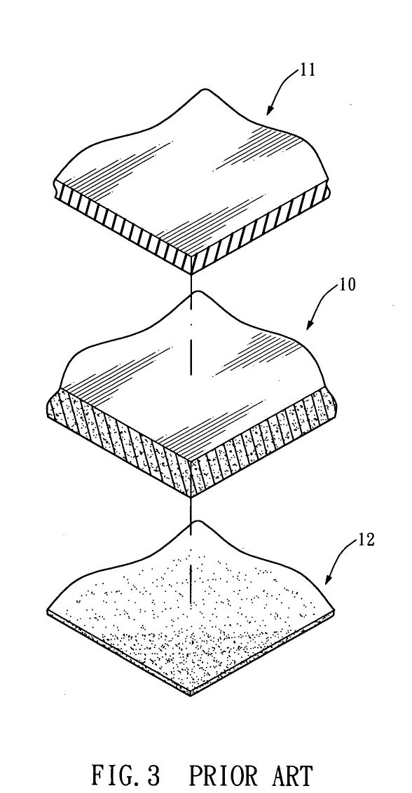

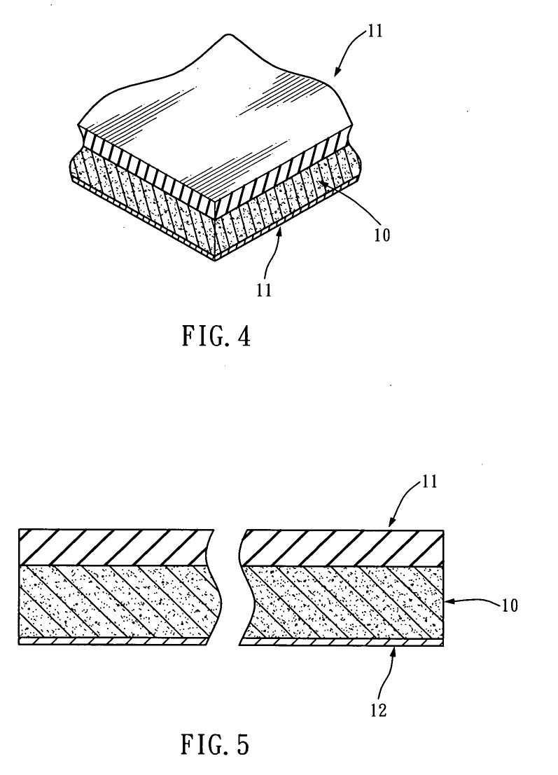

Referring to FIGS. 3 through 5, a surface layer 11 may be bound to one surface of the primary layer 10 by means of adhesion, thermal transfer or painting. The surface layer 11 may be selected from a slabstone, a wooden board, a bamboo board, a block board, a PVC, PET or PP board, a wooden plywood and an artificial wood board. An adhesive layer 12 is provided at an opposite layer of the primary layer 10 so that a user can easily affix the fire-resistant board to an external physical surface.

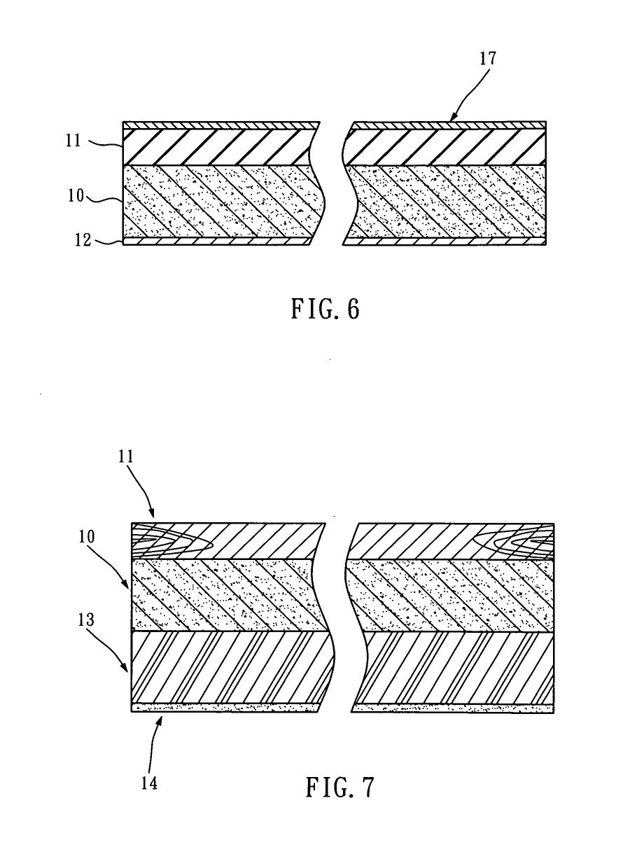

As shown in FIG. 6, when the surface layer 11 is a wooden board, a bamboo board, or a wooden plywood, it may have an outer surface painted so as to give gloss or present a desired color. A wooden veneer 17 may be alternatively provided at the outer surface of the surface layer 11 so as to give the fire-resistant board an artificial appearance simulating wood or other natural materials. Alternatively, a plastic film may be used for replacing the wooden veneer 17. The plastic film is bound with the outer surface of the surface layer 11 by means of thermal transfer. The plastic film may provide the surface layer 11 with various appearances simulating various nature materials. The plastic film may be made of PVC, PU, PET, PP, PE, PC and the like.

According to FIG. 7, in another embodiment of the present invention, a cushion layer 13 is provided at a lower surface of primary layer 10. While the primary layer 10 and the surface layer 11 are similar to their counterparts in the previous embodiment, the cushion layer 13 may be a thin pad made of a shock-absorbing material (e.g. EVA, Ethylene-Vinylene Acetate copolymer). Alternatively, the cushion layer 13 may be a thin pad made of nonwoven. The cushion layer 13 provides the fire-resistant board with improved shock-absorbing ability so as to adapt the laminated board to flooring applications. A self-adhesive layer 14 is applied to a lower surface of the cushion layer 13 so as to allow a user to easily affix the laminated board outside to a surface of an external object. Thus, the fire-resistant board of the present embodiment also has the advantages of easy application, time-saving installation, firm combination and suitability to the DIY construction of ordinary users.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A fire-resistant board comprising a primary layer mainly made of a composition comprised of a magnesite compound and carborundum.

2. The fire-resistant board of claim 1, wherein the magnesite compound comprises magnesium chloride, magnesium oxide, and magnesium sulfate.

3. The fire-resistant board of claim 2, wherein the primary layer includes magnesite compound ranging between 37 wt % and 47 wt %, carborundum ranging between 11 wt % and 21 wt %, wood flour ranging between 31 wt % and 41 wt %, crystal water ranging between 5 wt % and 8 wt %.

4. The fire-resistant board of claim 3, wherein the primary layer internally has at least a layer of fiberglass mesh cloth.

5. The fire-resistant board of claim 1, further comprising a surface layer bound to an upper surface of the primary layer.

6. The fire-resistant board of claim 5, wherein the surface layer is selected from the group consisting of a slabstone, a wooden board, a bamboo board, a block board, a PVC board, a wooden plywood and an artificial wood board.

7. The fire-resistant board of claim 5, wherein a heat transfer film is provided at an upper surface of the surface layer.

8. The fire-resistant board of claim 5, wherein a paint layer is provided at an upper surface of the surface layer.

9. The fire-resistant board of claim 5, wherein a wooden veneer is provided at an upper surface of the surface layer.

10. The fire-resistant board of claim 5, wherein a cushion layer made of a shock-absorbing material is settled at a lower surface of the primary layer.

11. The fire-resistant board of claim 10, wherein the cushion layer is a thin layer made of EVA (Ethylene-Vinylene Acetate copolymer).

12. The fire-resistant board of claim 10, wherein the cushion layer is a thin layer made of nonwoven.

13. The fire-resistant board of claim 5, wherein a plastic film with an artificial pattern simulating a pattern of a natural material is adhered to an upper surface of the surface layer.

14. The fire-resistant board of claim 13, wherein the plastic film is made of PVC, PU, PET, PP, PE or PC.

15. The fire-resistant board of claim 1, further comprising an adhesive layer provided at a lower surface of the primary layer.
